(19) United States
(12) Patent Application Publication
(10) Pub. No.: US 2018/0373899 A1
(43) Pub. Date: Dec. 27, 2018

(54) METHOD FOR CREATING A DECOY OF AN OPERATION OF AN INTEGRATED CIRCUIT AND CORRESPONDING INTEGRATED CIRCUIT

(71) Applicant: STMicroelectronics (Rousset) SAS, Rousset (FR)

(72) Inventors: Thomas ORDAS, Pourcieux (FR); Alexandre SARAFIANOS, Pourrieres (FR)

(73) Assignee: STMicroelectronics (Rousset) SAS, Rousset (FR)

(21) Appl. No.: 16/012,191

(22) Filed: Jun. 19, 2018

(30) Foreign Application Priority Data
Jun. 22, 2017 (FR) 1755687

(51) Int. Cl. G06F 21/75; H04L 9/00

(52) U.S. Cl. CPC G06F 21/75; H04L 2209/08; H04L 9/002

(57) ABSTRACT

A circuit module of an integrated circuit is located in a first zone of a semiconductor substrate. A decoy cell includes an antenna above a second zone of the semiconductor substrate. The second zone is different from the first zone. A generation circuit operates to generate a decoy electrical signal on the basis of a first electrical signal that is characteristic of an operation of the circuit module and of at least one pseudo-random parameter. The decoy electrical signal is circulated through the antenna so as to generate a decoy electromagnetic radiation.

### PRIORITY CLAIM

This application claims the priority benefit of French Application for Patent No. 1755687, filed on Jun. 22, 2017, the disclosure of which is hereby incorporated by reference in its entirety to the maximum extent allowable by law.

### TECHNICAL FIELD

Modes of implementation and embodiments of the invention relate to integrated circuits, especially but not exclusively those including secure modules, and in particular to the protection of this type of circuit from side channel analyses, and more particularly from analyses of the electromagnetic signals produced by the integrated circuit during its operation.

### BACKGROUND

In operation, an integrated circuit produces electromagnetic signals by way of metal tracks of the integrated circuit, for example during switching of its logic components. By analyzing these electromagnetic signals, using for example an antenna and dedicated mathematical algorithms, it is possible to obtain information on the operations performed and on the data manipulated and/or on their occurrences.

There is therefore a need to protect an integrated circuit from such electromagnetic signal analyses.

### SUMMARY

To this end, according to one embodiment and mode of implementation, provision is made for creating a decoy simulating the operation of a module of the integrated circuit to be protected and located spatially at a site of the substrate other than that of the module. Thus, according to one embodiment and mode of implementation, a device and a method are proposed that make it possible to simulate the electromagnetic emissions of a module so as to make it even more difficult to deduce the operations performed by the module.

According to one aspect, a method is proposed for creating a decoy of an operation of at least one module that is located in at least one first zone of a semiconductor substrate of an integrated electronic circuit, comprising an arrangement of at least one first antenna above at least one second zone of the integrated circuit, which at least one second zone is different from said at least one first zone, a generation of at least one decoy electrical signal on the basis of at least one first electrical signal that is characteristic of an operation of said at least one module and of at least one pseudo-random parameter, and a circulation of said at least one decoy electrical signal through said at least one first antenna so as to generate at least one decoy electromagnetic radiation.

Stated otherwise, electromagnetic signals are emitted that reproduce the operation of a module produced in a semiconductor substrate zone, the source of the signals being at a site of the substrate that is different than that at which said module is located.

The circulation of the electrical signal may comprise the generation of a decoy electrical signal comprising the generation of the first signal by said module, and a pseudo-random application of a delay to at least some of the edges of said first signal.

A decoy electrical signal is thus obtained having, in this instance, a pseudo-random form factor (said at least one characteristic).

According to one mode of implementation, when said module is in operation, the generation of said at least one first electrical signal comprises a delivery of at least one electrical signal by said module during its operation.

According to another mode of implementation, the generation of said at least one first electrical signal comprises a storage of at least one electrical signal delivered by said module during its operation, and a retrieval of the stored electrical signal when said module is not in operation.

The module delivers an electrical signal both when it is in operation and when it is not in operation.

According to one mode of implementation, the first antenna and at least one second antenna are arranged above at least one third zone of the integrated circuit, which at least one third zone is different from said at least one first zone and said at least one second zone, the method additionally comprising a selection of at least one of said antennas, and a circulation of said decoy electrical signal through said at least one selected antenna.

According to another aspect, an integrated circuit is proposed, comprising at least one module that is located in at least one first zone of a semiconductor substrate of the integrated circuit, and at least one decoy cell including at least one first antenna above at least one second zone of the integrated circuit, which at least one second zone is different from said at least one first zone, a generating circuit configured to generate at least one decoy electrical signal on the basis of at least one first electrical signal that is characteristic of an operation of said at least one module and of at least one pseudo-random parameter, and to circulate said at least one decoy electrical signal through said at least one first antenna so as to generate at least one decoy electromagnetic radiation.

The generation circuit may comprise a delay circuit configured to pseudo-randomly apply a delay to at least some of the edges of said first signal.

The delaying circuit may be configured to pseudo-randomly apply a fixed or variable delay to at least some of the edges of said first signal.

According to one embodiment, the integrated circuit additionally comprises an interconnect region (known to those skilled in the art by the acronym BEOL for “back end of line”) comprising multiple metallization levels, at least one metallization level of which comprises at least one metal track forming at least one portion of said at least one first antenna.

According to another embodiment, the integrated circuit comprises the first antenna and at least one second antenna covering a third zone that is different from said at least one first zone and said at least one second zone, the decoy cell comprising a selection circuit configured to select at least one of said first and second antennas so as to deliver said decoy electrical signal to said at least one selected antenna.

The first antenna and said at least one second antenna may be located in one and the same metallization level of the interconnect region of the circuit.

According to another embodiment, the first antenna and said at least one second antenna are located in separate metallization levels of the interconnect region of the circuit.

The selection circuit may comprise a control register and logic gates that are coupled between said antennas and said control register.

### BRIEF DESCRIPTION OF THE DRAWINGS

Other advantages and features of the invention will become apparent upon examining the detailed description of completely non-limiting embodiments and modes of implementation of the invention and the appended drawings, in which:

FIGS. 1 and 2 illustrate an integrated circuit;

FIG. 3 is a partial cross-sectional view;

FIG. 4 schematically shows an exemplary embodiment of a generation circuit;

FIG. 5 illustrates signal variation over time;

FIGS. 6 and 7 illustrate another embodiment of an integrated circuit.

### DETAILED DESCRIPTION OF THE DRAWINGS

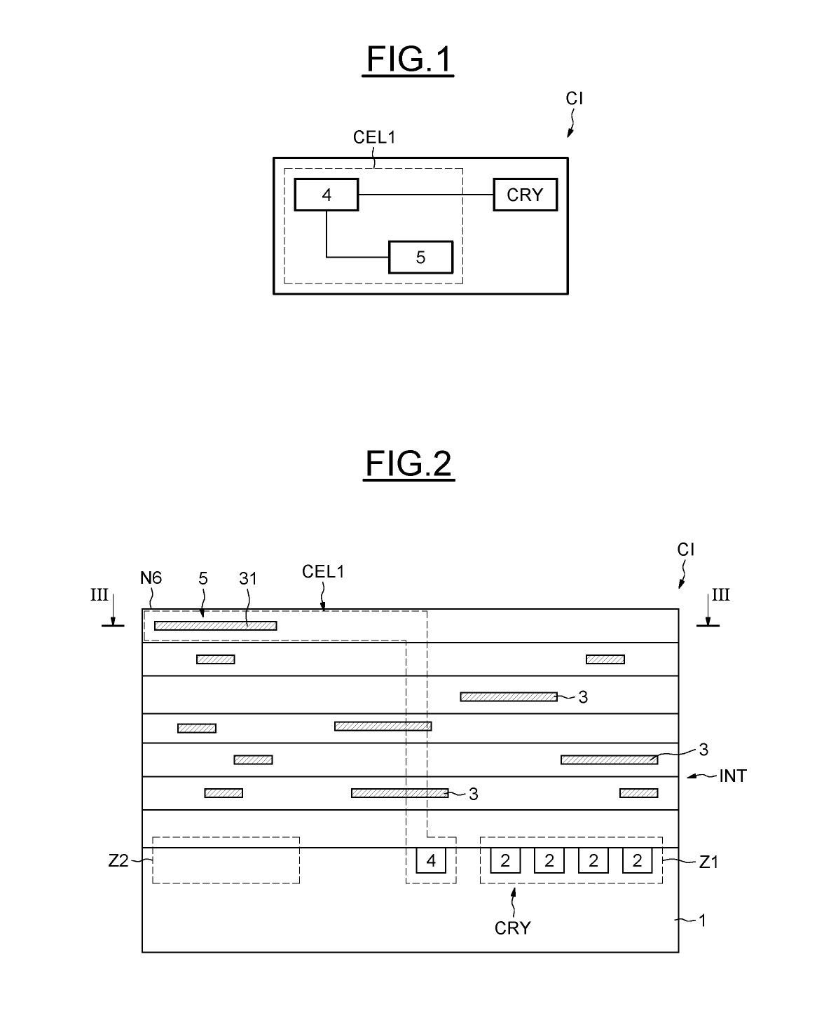

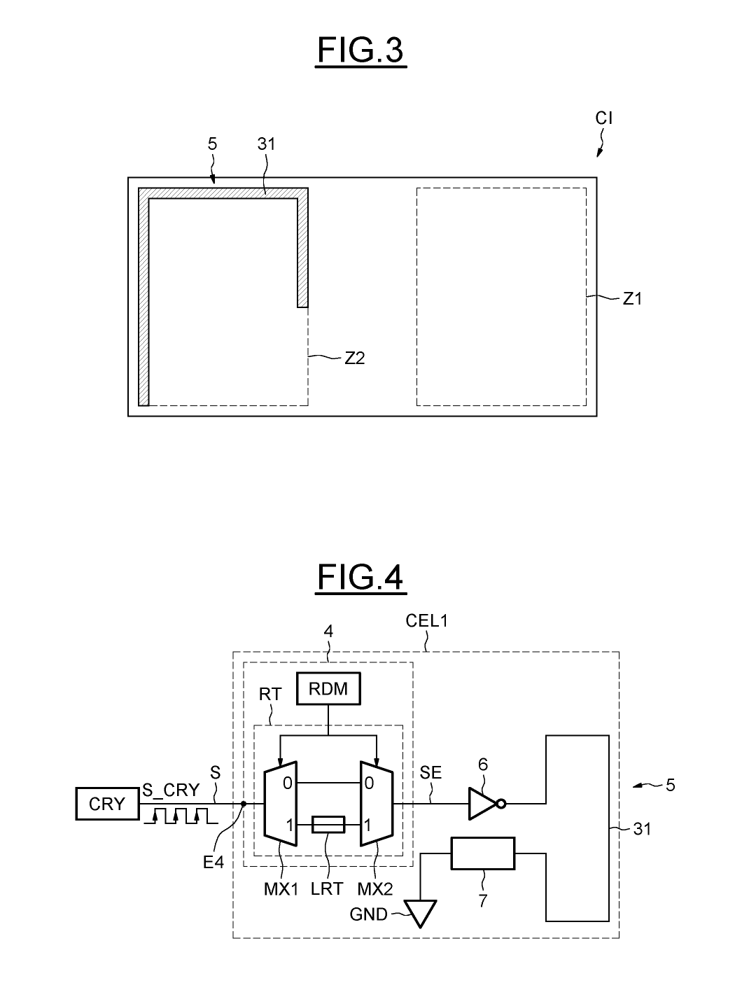

FIGS. 1 and 2 illustrate an integrated circuit CI, and FIG. 3 is a partial cross-sectional view along the section line in FIG. 2.

The integrated circuit CI includes a cryptographic circuit module CRY linked to a decoy cell CEL1. The decoy cell CEL1 comprises a generation circuit 4 connected to a transmitting antenna 5.

The integrated circuit CI includes a semiconductor substrate 1, in which a plurality of integrated circuit components 2 have been produced in a zone Z1 of the integrated circuit.

The integrated circuit components include here, in particular, logic gates which form, for example, the cryptographic circuit module CRY that is configured in particular to perform operations in a secure manner.

The substrate 1 is surmounted by an interconnect region INT (known to those skilled in the art by the acronym BEOL for “back end of line”) including multiple metal levels, each including one or more metal tracks 3 that are coated with an insulating material (known to those skilled in the art as an intermetal dielectric).

Some of the metal tracks 3 of the metal levels are interconnect tracks electrically linking at least some of the components 2 of the zone Z1 of the integrated circuit to one another by way of vias (not shown for the sake of simplicity).

Other metal tracks 3 may, for example, be power redistribution tracks or be linked to ground.

The sixth metallization level N6, which is the highest level here, includes a single metal track 31 that is not directly coupled to components of the cryptographic circuit module CRY, but, as will be seen below, forms the transmitting antenna 5 that is coupled by way of vias to the generation circuit 4 of the decoy cell CEL1. The generation circuit 4 is produced in and on the substrate 1 and is configured to generate a decoy electrical signal SE that includes a pseudo-random characteristic.

The generation circuit 4 is linked to the cryptographic circuit module CRY and is located at any site of the substrate 1, for example, as shown here, outside the cryptographic circuit module CRY.

The metal track 31 is located in a metallization level and above a second zone Z2 of the circuit CI, wherein the second zone is different from the first zone Z1.

In this example, the sixth metallization level N6 is therefore not an interconnect level since it does not include a metal track 3 linking at least some of the components 2 of the zone Z1 of the circuit to one another, but it is nonetheless produced using the same process as that used to produce the various metal levels.

However, it would be entirely possible to envisage the sixth metallization level N6 including metal interconnect tracks extending, for example, inside the perimeter delimited by the metal track 31.

It should be noted that the transmitting antenna 5 could comprise multiple metal loops located at different metallization levels that do not cover the cryptographic circuit module CRY and are linked by vias.

FIG. 4 schematically shows an exemplary embodiment of the generation circuit 4 that is electrically linked to the cryptographic circuit module CRY and configured to generate the decoy electrical signal SE.

The transmitting antenna 5 includes the metal track 31, a first end of which is coupled to a buffering element 6 (buffer circuit) that is conventionally used to amplify and shape the decoy signal SE that is generated by the generation circuit 4.

A capacitive element 7 is coupled between a second end of the metal track 31 and ground GND. The capacitive element is here used to draw a current to ground GND.

The buffering element 6 and the capacitive element 7 are components produced in and/or on the semiconductor substrate 1, and are electrically connected to the first metal track 31 by vias.

The generation circuit 4 which generates the electrical signal SE comprises an input E4 that is electrically linked to an output S_CRY of the cryptographic circuit module CRY and coupled to a delaying circuit RT, and a circuit generator RDM which generates pseudo-random values, the output of which is also coupled to the delaying circuit RT.

The cryptographic circuit module CRY transmits a first electrical signal S over its output S_CRY that is representative of an operation of the module, for example all or part of a cryptographic activity or of another activity.

The delaying circuit RT includes for example a delay line LRT that is configured to apply a delay to the rising edges of the first electrical signal S transmitted by the cryptographic circuit module CRY.

This delay line LRT is connected by way of a first multiplexer MX1 to the output S_CRY of the module CRY and is connected by way of a second multiplexer MX2 to the input of the buffering element 6.

A direct path, i.e. without delay, is also connected between the other inputs of the two multiplexers.

These multiplexers MX1 and MX2 are controlled by the binary value 0 or 1 delivered by the circuit generator RDM of pseudo-random values.

Depending on the value generated by the circuit generator RDM, the delaying circuit RT may or may not select the delay line LRT, so that at least some of the rising edges of the first electrical signal S transmitted by the cryptographic circuit module CRY are delayed or not delayed pseudo-randomly.

While in this embodiment the delay of the delay line LRT is fixed (constant), it would be possible, as a variant, to provide a delay line configured to have a variable delay, for example pseudo-randomly, depending on the logic value delivered by another generator of pseudo-random numbers.

When the cryptographic circuit module CRY is handling encryption operations, the output S_CRY transmits a square electrical signal S that reproduces all or part of the activity of the module CRY.

Thus, in the same way as the metal interconnect tracks 3 generate electromagnetic signals depending on the operations carried out by the cryptographic circuit module CRY, the metal track 31 of the antenna 5 generates additional decoy electromagnetic signals when the decoy signal SE flows therethrough, which signals correspond to the first electrical signal S delayed by a pseudo-random delay which, by summing with the electromagnetic signals emitted by the metal tracks 3, make it more difficult to analyze the overall electromagnetic signature of the integrated electronic circuit CI.

These decoy signals reproduce the operation of a second cryptographic circuit module operating at the same time as the cryptographic circuit module CRY.

When the cryptographic circuit module CRY is not handling encryption operations, the output S_CRY retrieves an electrical signal S that is stored in a memory and that has been delivered by the module CRY during its operation, i.e. when it is handling encryption operations.

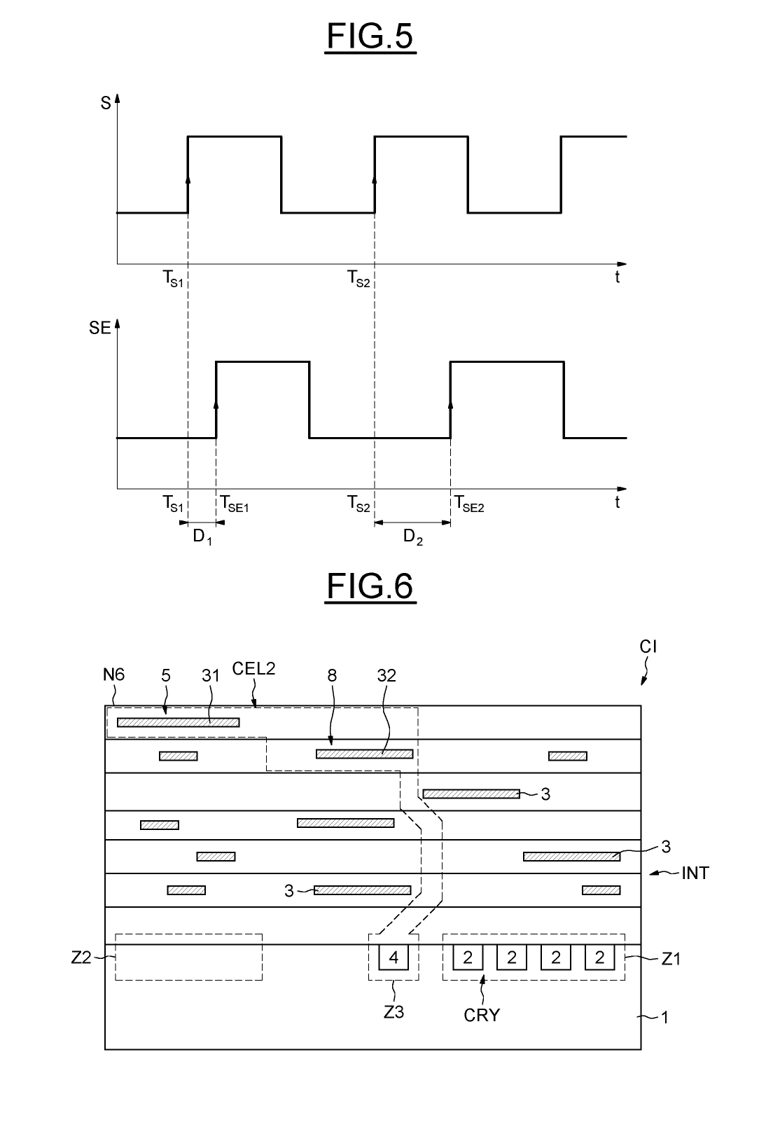

FIG. 5 illustrates the variation of the signals S and SE over time.

It should be noted that the first rising edge at time T_{SE1} of the signal SE transmitted by the generation circuit 4 is delayed by a duration D1 with respect to the first rising edge at time T_{S1} of the signal S transmitted by the cryptographic circuit module CRY.

It should also be noted that the second rising edge at time T_{SE2} of the signal SE transmitted by the generation circuit 4 is delayed by a duration D2 with respect to the first rising edge at time T_{S2} of the signal S transmitted by the cryptographic circuit module CRY, the durations D1 and D2 being different and chosen pseudo-randomly by the generator RDM of pseudo-random values.

Thus, the metal track 31 of the antenna 5 generates electromagnetic signals corresponding to the operation of the cryptographic circuit module CRY delayed by a pseudo-random delay.

In addition, since the metal track 31 of the antenna 5 is located away from the cryptographic circuit module CRY, it is more difficult to locate the cryptographic circuit module CRY in the integrated electronic circuit CI.

Specifically, if the cryptographic circuit module CRY is active, analysis of the electromagnetic signals reveals two signals that are delayed with respect to one another by a pseudo-random duration arising from two different sites of (locations on) the integrated circuit CI.

This delay between the two signals prevents the resynchronization of the two signals.

If the cryptographic circuit module CRY is not active, the metal track 31 of the antenna 5 emits a signal reproducing the operation of an imaginary cryptographic circuit module arising from a site of (location on) the integrated electronic circuit CI other than that at which the cryptographic circuit module CRY is located.

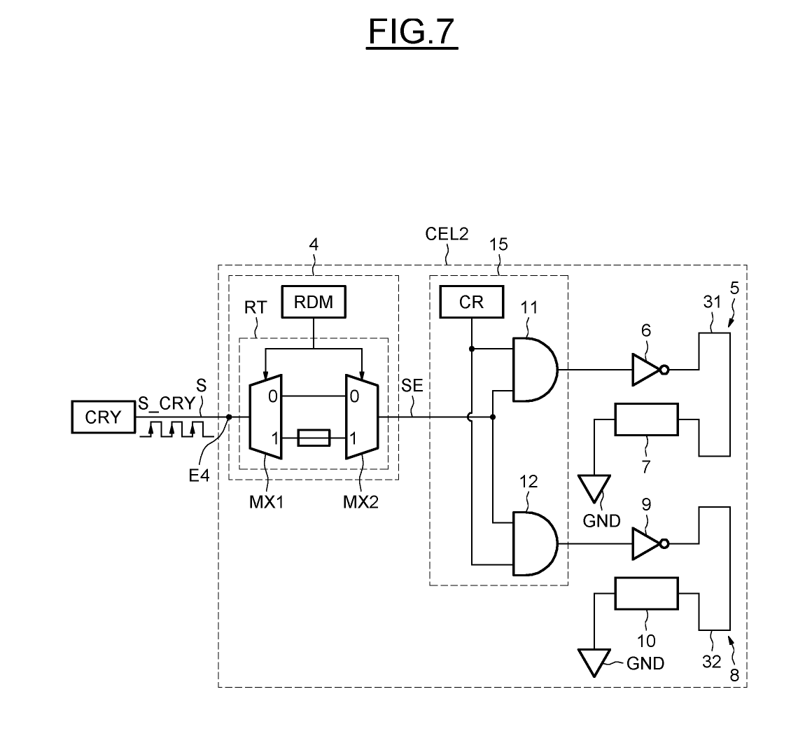

According to another embodiment illustrated in FIGS. 6 and 7, the integrated electronic circuit CI includes a second antenna 8 including a second metal track 32 that is located in the fifth metal level N5 and covering a third zone Z3 of the semiconductor substrate 1, wherein the third zone is different from the zones Z1 and Z2.

According to another embodiment (not shown), the antenna 8 is superposed over the antenna 5, stated otherwise the antenna 8 covers the zone Z2.

As illustrated in FIG. 7, the integrated circuit includes a decoy cell CEL2 including a selection circuit 15 that are coupled to the generation circuit 4 and to the first and second antennas 5 and 8.

The selection circuit 15 comprises in this exemplary embodiment a control register CR, a first “AND” logic gate 11 and a second “AND” logic gate 12, and are configured to select the one or more antennas that will receive the electrical signal SE.

The two logic gates 11 and 12 each include two inputs, a first input of which is coupled to the control register CR, and a second input of which is coupled to the output of the generation circuit 4.

The first logic gate 11 includes an output coupled to the first antenna 5 and the second logic gate 12 includes an output coupled to the second antenna 8.

Thus, during the operation of the circuit, the control register CR sets the first inputs of the logic gates that are coupled to the antennas that it selects to one, so that, during the generation of a rising edge of the electrical signal SE, only the logic gates selected by the control register CR transmit the electrical signal SE to the antenna that is associated therewith.

The selection of the antennas by the control register CR may depend on operations performed by the cryptographic circuit module CRY, or as a variant, be made pseudo-randomly.

It should be noted that the embodiments and modes of implementation presented here are completely non-limiting. In particular, although the integrated circuits shown here include one or two antennas, it is entirely possible to envisage an integrated circuit including a larger number of antennas, the metal tracks of which are located in one or more metal levels, above one or more zones of the integrated circuit not covering the cryptographic circuit module CRY.

Moreover, whereas the pseudo-random characteristic of the electrical signal SE described above was the form factor of the signal, it would be possible to envisage other characteristics of the signal that could be modified pseudo-randomly, such as for example its amplitude and/or its phase.

1. A method for creating a decoy of an operation of at least one circuit module that is located in at least one first zone of a semiconductor substrate of an integrated electronic circuit which includes an arrangement of at least one first antenna above at least one second zone of the semiconductor substrate, wherein the at least one second zone is different from said at least one first zone, comprising:
generating at least one decoy electrical signal on the basis of at least one first electrical signal that is characteristic of an operation of said at least one circuit module and of at least one pseudo-random parameter, and
circulating said at least one decoy electrical signal through said at least one first antenna so as to generate at least one decoy electromagnetic radiation.

2. The method according to claim 1, wherein generating the at least one decoy electrical signal comprises:
generating a first signal output by said at least one circuit module, and
pseudo-randomly applying a delay to at least some of the edges of said first signal.

3. The method according to claim 2, wherein said delay is one a fixed delay.

4. The method according to claim 2, wherein said delay is a variable delay.

5. The method according to claim 1, wherein, when said at least one circuit module is in operation, generating said at least one first electrical signal comprises delivering at least one electrical signal output by said at least one circuit module during said operation.

6. The method according to claim 1, wherein generating said at least one first electrical signal comprises:
storing at least one electrical signal delivered by said at least one circuit module during operation,
retrieving the stored at least one electrical signal when said at least one circuit module is not in operation, and
using the retrieved at least one electrical signal to generate said at least one first electrical signal.

7. The method according to claim 1, wherein the first antenna and at least one second antenna are arranged above a third zone of the semiconductor substrate, wherein sad third zone is different from said at least one first zone and said at least one second zone, the method further comprising:
selecting at least one of said first and second antennas, and
circulating said decoy electrical signal through the selected antenna.

8. An integrated circuit, comprising:
at least one circuit module that is located in at least one first zone of a semiconductor substrate of the integrated circuit;
at least one decoy cell including at least one first antenna located above at least one second zone of the semiconductor substrate, wherein said at least one second zone is different from said at least one first zone; and
a generation circuit configured to generate at least one decoy electrical signal on the basis of at least one first electrical signal that is characteristic of an operation of said at least one circuit module and of at least one pseudo-random parameter;
wherein said at least one decoy electrical signal is circulated through said at least one first antenna so as to generate at least one decoy electromagnetic radiation.

9. The integrated circuit according to claim 8, wherein the generation circuit comprises a delay circuit configured to pseudo-randomly apply a delay to at least some edges of said at least one first electrical signal.

10. The integrated circuit according to claim 9, wherein the delay circuit is configured to pseudo-randomly apply a fixed delay to at least some edges of said at least one first electrical signal.

11. The integrated circuit according to claim 9, wherein the delay circuit is configured to pseudo-randomly apply a variable delay to at least some of the edges of said first signal.

12. The integrated circuit according to claim 8, further comprising:
an interconnect region comprising multiple metallization levels, wherein at least one metallization level comprises at least one metal track forming at least one portion of said at least one first antenna.

13. The integrated circuit according to claim 8, wherein the first antenna and at least one second antenna cover a third zone of the semiconductor substrate that is different from said at least one first zone and said at least one second zone, and wherein the at least one decoy cell comprises a selection circuit configured to select at least one of said first and second antennas and deliver said decoy electrical signal to said selected antenna.

14. The integrated circuit according to claim 13, wherein the first antenna and said at least one second antenna are located in one and the same metallization level of the interconnect region.

15. The integrated circuit according to claim 13, wherein the first antenna and said at least one second antenna are located in separate metallization levels of the interconnect region.

16. The integrated circuit according to claim 13, wherein the selection circuit comprise a control register and logic gates that are coupled between said antennas and said control register.
